(19) United States
(12) Patent Application Publication
(10) Pub. No.: US 2011/0017104 A1
(43) Pub. Date: Jan. 27, 2011

(54) Combination Table Top Cover and Skirt Retainer

(76) Inventor: Philip A. DiTrolio, Suwanee, GA (US)

Correspondence Address: Balser & Grell IP Law LLC, 4307 Jones Bridge Circle, Norcross, GA, 30092, US

(21) Appl. No.: 12/508,548

(22) Filed: Jul. 23, 2009

(51) Int. Cl. A47B 13/08; A47B 37/00; A47G 23/00; B23P 17/04

(52) U.S. Cl. 108/50.11; 29/428

(57) ABSTRACT

An apparatus and method for affixing a table skirt to a table top cover comprising, a semi-rigid reusable table top cover for covering a table top and side surfaces of the table top, and, thus, functions to cover a table top having existing damage from staples or general wear to provide a uniform table top surface for affixing and removing table skirting without the use of staples.

### TECHNICAL FIELD

This disclosure relates to a combination table top cover and skirt retainer, and more specifically to a one piece rigid table top cover to provide an alternate surface appearance and having a sidewall for separately attaching a table skirt.

### BACKGROUND

It has long been the custom to install a drape forming a table skirt on banquet, ceremony, speaking, expo, and trade show tables, particularly, when the table is on a raised platform or otherwise elevated as is most often the case with the speakers' table. The usual approach is to cover the tables with a tablecloth and attach decorative skirting to the tablecloth around the periphery of the top of the table so as to generally conceal the legs of the table and therefore enhance the appearance of the table. The skirting itself is generally custom made for a customer to correspond to the specific size of the tables and color request specified by the customer or matching decorations of the particular hall or event theme.

Various arrangements have been employed in mounting the skirt on the table. The most common technique is tacking or stapling the top margin of the table skirt, which is frequently pleated and reinforced with some type of binding tape, onto the vertical side edge of a wooden table top or alternatively on the table top near the table edge. This requires considerable time to accomplish the task of affixing a table skirt to each of multiple tables for a large banquet, expo, or tradeshow, which is frequently required to be done hurriedly. In addition, problems often occur with continuous stapling of the skirting to the sidewalls of the table top. The staples often damage the wood table top sides upon insertion. And when the skirting is removed after the show; the skirting is torn off, leaving the staples in the table (need to be removed) or splinters where the staples have been removed. This damage greatly reduces the life span of the table, as well as many wasted man hours removing the left over staples by hand using a staple removal tool.

An additional problem is the accumulation of staples on the sidewall of the table; it becomes increasingly difficult to install the skirting. When the tables are delivered as well as removed from the event, they are placed on table dollies. During this procedure it is very common for equipment handlers to become injured from protruding staples. In addition, during such events, exhibitors themselves and attendees can become injured. Also, clothing and trade show materials can become damaged from protruding un-removed staples.

An even simpler means of affixing the skirt to the table top employs sewing a band of tape onto the skirt to form a base for receiving pins which will affix the skirting to the tablecloth or alternatively using pieces of material that adhere to one another for attaching the skirting directly to the tablecloth and not to the tabletop itself. In addition, fitted table clothes based on elastic materials, elastic sewn along an edge of the table cloth, or drawstring along the edge of the table cloth have been employed for the purpose of creating a tightly fitted table top cloth appearance.

Consequently, some efforts have been made to provide a more expeditious way of attaching the skirt so as to reduce the time and labor involved in set up. To this end various clip arrangements have been devised, similar in manner to that of drapery hanging arrangements, but these have not been entirely acceptable because of frequent breakage due to lack of strength, slippage due to beveled edges of the table top, marring the surface of the table top, or unwanted exposure of the clip mechanism on the upper surface of the table (table top).

Numerous clips have been proposed for various purposes. An example table clip is manufactured from a flexible plastic or metal and functions to grasp the edge of the table top and provide either a surface area to affix a hook and loop system, tab or hook for attaching the skirting directly to the table clip. Such clips are strategically located around the table edge and affix the top of the decorative skirt to complete the application of the skirt to the table. Users of plastic clips must stock a different clip for every table they use if the thicknesses of the tables differ. Metal clips generally are adjustable and may be used for more than one thickness of table. However, a major drawback of metal clips is that the metal clip is visible against the table cover.

Therefore, it is readily apparent there is a need for a combination table top cover and skirt retainer that functions to quickly accomplish the task of affixing table skirts to multiple tables for a large banquet, expo or tradeshow without damaging the underlying wood table, leaving behind multiple staples, and visually exposing the skirt mounting system, while covering table tops having existing damage from staple usage and providing a uniform table top surface.

### BRIEF SUMMARY

Briefly described, in the preferred embodiment, the present disclosure overcomes the above-mentioned disadvantages and meets the recognized need for such a device by providing a combination table top cover and skirt retainer comprising, in a generally preferred manner, a semi-rigid reusable table top cover for covering a table top and side surfaces of the table top, and, thus, functions to cover a table top having existing damage from staples or general wear to provide a uniform table top surface for affixing and removing table skirting without the use of staples.

According to its major aspects and broadly stated, the present disclosure in its preferred form is a reusable table top cover for a folding table comprising a semi-rigid plastic sheet having a uniform top and four sidewalls so that the cover may be placed over the table top. The cover has a body with a width and a length accommodating the width and length of the folding table top.

More specifically, the preferred embodiment of the present combination table top cover and skirt retainer comprises a reusable table top cover constructed of a thin mil plastic material having a textured top surface and four sidewalls utilized to cover the table top and four side surfaces of the table top. Preferably, the four sidewalls of the table top cover have an alternating indented and raised pattern, which functions to provide strength to the table top cover as well as an indented surface to position and affix hook or loop fasteners in the alternating indented sections. A table skirt with a strip of the hook or loop fasteners running the length of the table skirts header is used to affix the table skirt to the hook or loop fasteners positioned in the alternating indented sections.

A combination table top cover and table skirting retainer system comprising a table top cover having a planar top and one or more sides, each side extending downwardly from the planar top, one or more indentations formed in at least one side, at least one table skirt having a first end opposite a second end; and fastening means for detachably affixing the table skirt to the table top cover.

A method of forming a combination table top cover and table skirting retainer, the method comprising the steps of providing a table top cover having a planar top and one or more sides, each side extending downwardly from the planar top, wherein each side having one or more indentations formed in at least one side, providing at least one table skirt having a first end opposite a second end, and detachably affixing the table skirt to the table top cover.

A combination table top cover and table skirting retainer system comprising a table top cover having a planar top and one or more sides, each side extending downwardly from the planar top, one or more indentations formed in at least one side, at least one table skirt having a first end opposite a second end; and a fastener, wherein said fastener detachably affixes the table skirt to the table top cover.

Accordingly, a feature of the combination table top cover and skirt retainer is its ability to cover a wooden table top that has exposed staples, splinters where staples have been removed, scratches, and chips due to use of the table or damage caused during stacking and un-stacking of the table in between uses creating a smooth table top work surface.

Another feature of the combination table top cover and skirt retainer is its ability to quickly dress a standard banquet, ceremony, speaking, expo, or trade show table with skirting without using staples.

Yet another feature of the combination table top cover and skirt retainer is its ability to provide indentations along sidewalls of the table top cover for affixing hook and loop fasteners and the like.

Still yet another feature of the combination table top cover and skirt retainer is its ability to provide rounded table corners to eliminate any table top sharp corners or edges; thus, reducing the possibility of tearing a table cloth fitted over the table top and also prevents one from bumping into or falling against a sharp corner or edge of table.

Still yet another feature of the combination table top cover and skirt retainer is its ability to provide a smooth straight adjoining seam between table skirting and table top cover.

Still yet another feature of the combination table top cover and skirt retainer is that the alternating indented sections enable hook and loop fastener to be recessed within indented sections preventing a wavy appearance along adjoining seams between the table skirting and the table top cover.

These and other features of the combination table top cover and skirt retainer will become more apparent to one skilled in the art from the following Detailed Description of the Preferred and Selected Alternate Embodiments and Claims when read in light of the accompanying drawing Figures.

### BRIEF DESCRIPTION OF THE DRAWINGS

The present combination table top cover and skirt retainer will be better understood by reading the Detailed Description of the Preferred and Selected Alternate Embodiments with reference to the accompanying drawing Figures, in which like reference numerals denote similar structure and refer to like elements throughout, and in which:

FIG. 1 is perspective view of standard folding table known in the prior art;

FIG. 2 illustrates installation of a table skirting to a folding table shown in FIG. 1 according to a method known in the prior art;

FIG. 3 is perspective view of a table top cover according to an example embodiment; and

FIG. 4 is perspective view of a combination table top cover and skirt retainer according to an example embodiment.

### DETAILED DESCRIPTION

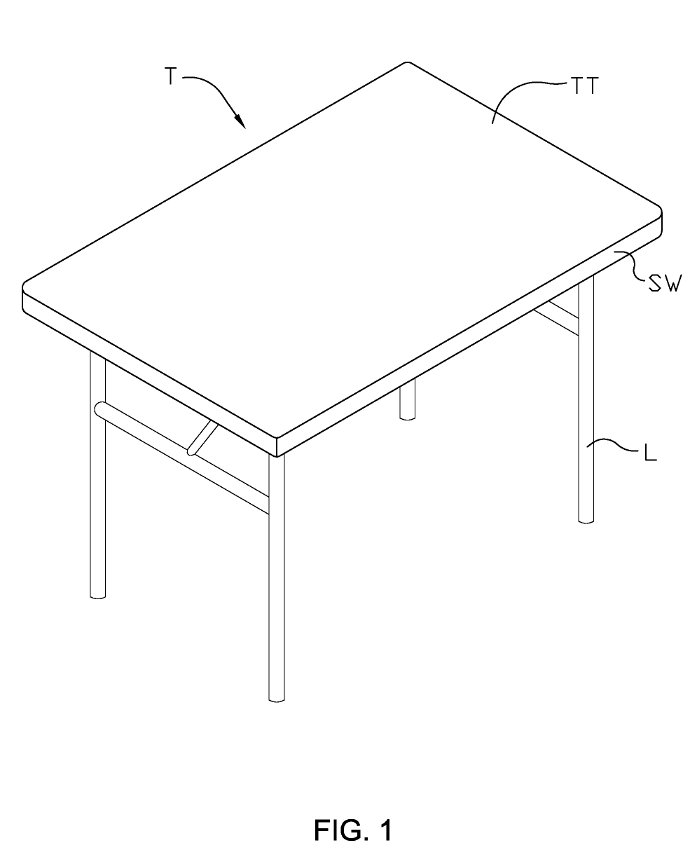

In describing embodiments of the combination table top cover and skirt retainer, as illustrated in FIGS. 1-4, specific terminology is employed for the sake of clarity. The combination table top cover and skirt retainer, however, is not intended to be limited to the specific terminology so selected, and it is to be understood that each specific element includes all technical equivalents that operate in a similar manner to accomplish similar function.

Referring now to FIG. 1, there is illustrated a perspective view of a standard folding table T, which comprises tables with fixed and folding legs L, whether used for banquet, ceremony, speaking, expo, or trade show purposes. Typically, table T includes table top TT having sidewall SW wherein such table top TT and sidewall SW are formed of a suitable material, such as wood, plastic, metal, cardboard, rubber, foam, laminate or the like, capable of providing structure to table top TT and sidewall SW. Existing U.S. standard size tables T are typically 24 inches wide (table top TT), for instance, with the dimension of 24 (or 30 width is common) inches by 48 inches (4 foot table), 24 inches by 72 inches (6 foot table) and 24 inches by 96 inches (8 foot table) and having a 2 and ½ inch drop or sidewall SW (i.e., thickness) on all sides, respectively. Other table T sizes and shapes are also available and contemplated herein including, but not limited to, 18 inch wide tables and 30 inch wide tables with various lengths. FIG. 1 illustrates a typical dimension of standard six foot table T, for example.

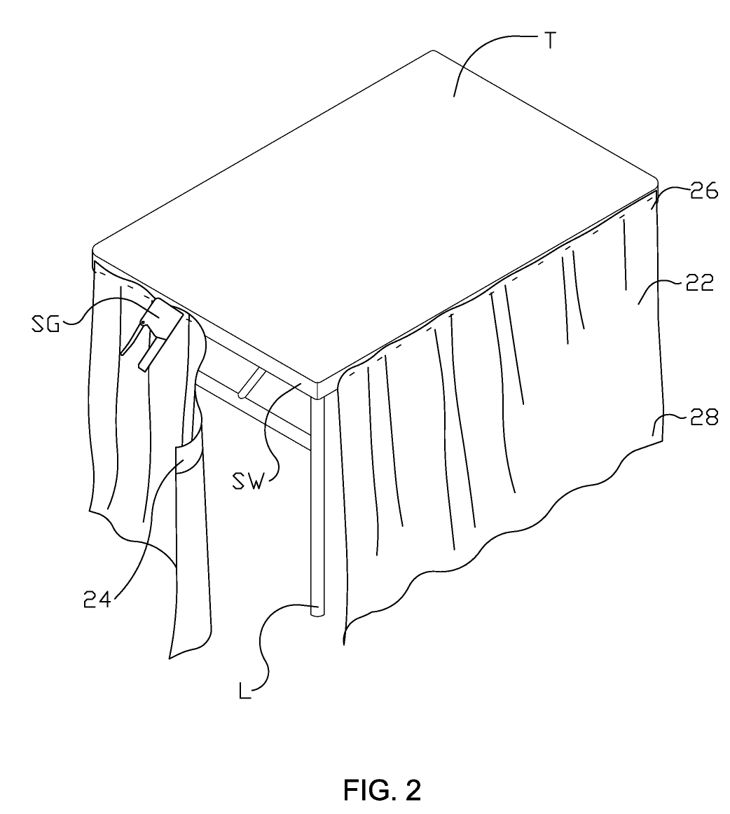

Referring now to FIG. 2, there is illustrated a perspective view of the standard folding table T shown in FIG. 1 with application of a table skirt or table skirting 22 to the sidewall SW of table T by driving a staple through table skirting 22 into sidewall SW of table T, as shown with staple gun SG. With reference now to FIG. 2, table skirting 22 is preferably an elongated cloth segment(s) each having a first end 26 opposite a second end 28 formed of fabric, as fabric offers a variety of colors and forms; however, other suitable materials such as plastic, vinyl, polyester or the like, may be utilized, provided such material has sufficient strength, style, conceal-ability and/or durability as would meet the purpose described herein. First end (upper end) 26 is preferably attached to sidewall SW of table T and second end 28 hangs vertically below first end 26. Preferably, table skirting 22 has a width for suitably covering the sides of the table T, and may be provided in a roll for use in cutting to a desired length and width to surround at least the front side, and more preferably at least the front and two lateral sides of table T. Alternatively, table skirting 22 may be provided in a predetermined standard length. For example, table skirting 22 can have a precut length of approximately 10-22 feet, and more specifically 14 feet. When using this 14 foot long table skirting 22, a standard eight-foot (8 foot) table (2 feet by 8 feet) can be covered by the front (8 feet) and two lateral sides (2+2, i.e., 4 feet), and a portion of the rear side, that is, about one foot wrapped on each lateral side of the rear side of table T (8+4+1+1=14 feet). Likewise, a standard six-foot table (2 feet by 6 feet) can be covered by the front (6 feet) and two lateral sides (4 feet) and about two feet on each lateral side of the rear side, and a standard four-foot table (2 feet by 4 feet) can be entirely covered on all sides of the table that is 12 foot long (i.e., 4+4+2+2) leaving two foot of overlap.

Moreover, table skirting 22 may be provided with a reinforcement band 24 running along the top horizontal inside edge of table skirting 22 to provide strength and support when stapling table skirting 22 to sidewall SW of table T and when pulling or tugging on table skirting 22 to remove table skirting 22 from sidewall SW of table T.

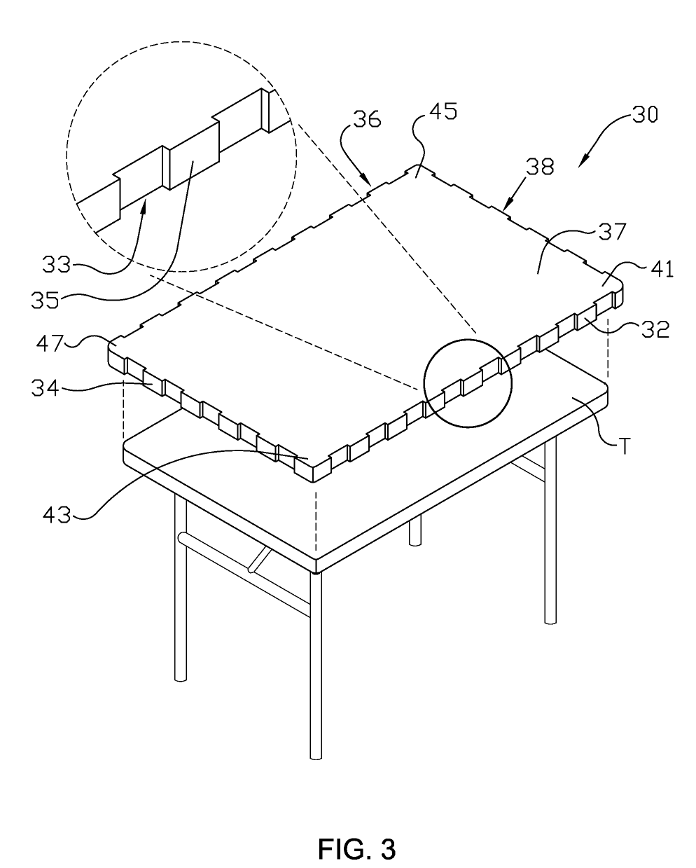

Referring now to FIG. 3, by way of example, and not limitation, there is illustrated a perspective view of table top cover 30 shown above table T. Preferably, table top cover 30 comprises sides 32, 34, 36, and 38, and planar top 37, arranged in a thin, rigid shell with a planar midsection and a length and width corresponding to cover table T. However, table top cover 30 is not intended to be limited to any particular size or configuration of table top TT. In addition, table top cover 30 is also applicable to any custom made tables with a wide variety of different sizes or to tables for home, exhibition, or office use. It is also applicable to table top TT having a rectangular, hexagonal, other polygonal configuration, or round or elliptical configuration. Sides 32, 34, 36, and 38, preferably depend downwardly or extend from opposite sides of planar top 37. Sides 32, 34, 36, and 38, and top planar are preferably formed of a suitable material, such as recycled ABS plastic, plastic, metal, cardboard, rubber, foam, laminate or the like, capable of providing structure to table top cover 30. Preferably, the material includes other suitable characteristics, such as rigidity, durability, water-resistance, light weight, flat surface, cost-effective, heat-resistance, corrosion resistance, ease of workability, or other beneficial characteristic understood by one skilled in the art. Sides 32, 34, 36, and 38, and planar top 37 may alternatively include a textured flat surface or fabric sheet such as linen, velvet, flock, faux leather (Vienna™), faux suede or the like, or a high friction material, such as a soft rubber or polymer, or the like covering an exterior surface of sides 32, 34, 36, and 38, and planar top 37.

Corners 41, 43, 45, and 47 of table top cover 30 are preferably rounded to eliminate any table top TT sharp corners or edges; thus, reducing the possibility of tearing a table cloth fitted over table top cover 30 and also prevents one from bumping into or falling against a sharp corner or edge of table top TT when table top cover 30 is placed over table top TT.

Moreover, sides 32, 34, 36, and 38 of table top cover 30 preferably have alternating indented square or rectangular sections 33 between non-indented sections 35 running the vertical perimeter of planar table top cover 30. Preferably, alternating indented sections 33 and non-indented sections 35 collectively function to provide rigidity and strength to table top cover 30. Although the foregoing describes the preferred configuration, shape and material selections for the manufacture of sides 32, 34, 36, and 38, and planar top 37 of table top cover 30, it should be recognized that sides 32, 34, 36, and 38, and planar top 37 may comprise alternate configurations, shapes, and/or material selections for indented sections 33 and non-indented sections 35 to accommodate for the different uses of table top cover 30 set forth herein. Indented shall include forming a recess in, notching, indentations, channel, or groove, whether in sections or continuous, and the like known to one of ordinary skill in the art. Furthermore, it should be recognized that any number of indented sections 33 and non-indented sections 35 may be manufactured in sides 32, 34, 36, and 38 of table top cover 30 for the purpose of strengthening table top cover 30.

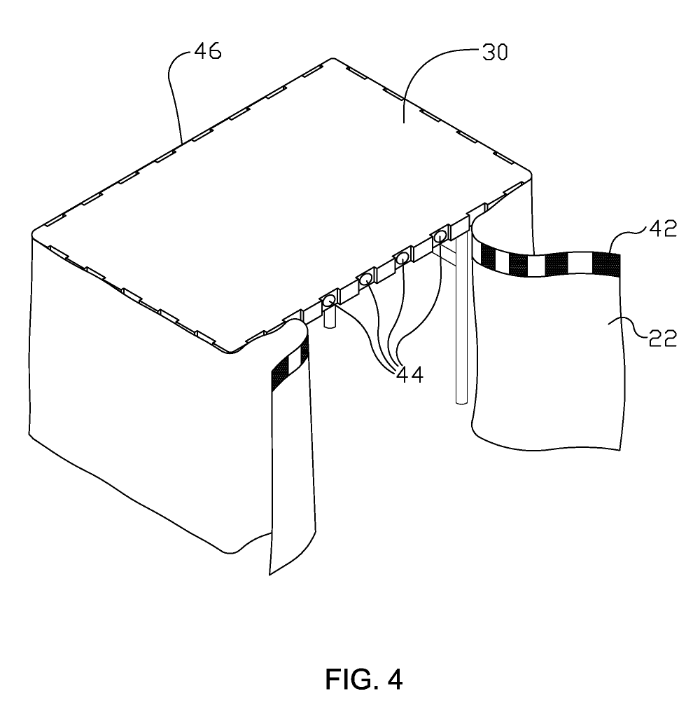

Referring now to FIG. 4, by way of example, and not limitation, there is illustrated a perspective view of a combination table top cover and skirt retainer. Preferably, a matching table top cover 30 is placed over and covers table top TT of table T. Table top cover 30 covers any exposed staples, splinters where staples have been removed, scratches, chips, worn or rough edges caused by repeated use of table top TT as well as stacking and un-stacking of table T between uses; thus creating a smooth uniform table top surface. In addition, table top cover 30 provides rounded corners 41, 43, 45, and 47 of table top cover 30 to eliminate any table top TT sharp corners or edges; thus, reducing the possibility of tearing a table cloth fitted over table top cover 30 and also prevents one from bumping into or falling against a sharp corner or edge of table top TT when table top cover 30 is placed over table top TT.

In use, indented sections 33 of table top cover 30 are preferably utilized to position either of a hook and loop fastener 42 or 44 via glue or self adhesive backed hook and loop fastener 42 or 44. It should be recognized that sides 32, 34, 36, and 38, may comprise alternate configurations, shapes, and/or material selections of alternating indented sections 33 to accommodate or match the size and shape of selected hook and loop fastener 42 or 44. The other set of hook and loop fastener 42 or 44, not utilized within indented sections 33, preferably is affixed to table skirting 22 or reinforcement band 24 of table skirting 22, if provided. The other set of hook and loop fastener 42 or 44 runs the entire length of table skirting 22 along reinforcement band 24 or alternatively is individually positioned along table skirting 22 or reinforcement band 24 spaced so as to be opposite or matched up with alternating indented sections 33 of table top cover 30. Moreover, it should be further recognized that other releasable attachment fastener systems may be utilized to releasably or permanently affix table skirting 22 to table top cover 30, including but not limited to snaps, hooks and grommets, magnets, or other attachment/fastener systems known to one of ordinary skill in the art. In addition, it should be further recognized that table skirting 22 may be manufactured or precut to size to accommodate existing size tables T whether to cover the entire perimeter of table T, cover individual sections of table T, cover one or more sections of table T, or cover three sides of table T allowing for chair and leg insertion into the remaining open side of table T. As such, table skirting 22 can be cut in advance to cover the existing tables of one or many different dimensions.

In use, a free end of table skirting 22 is first affixed to a select indented section 33 of table top cover 30 positioned on table T and thereafter each hook and loop fastener 42 and 44 preferably is mated to one-another along the perimeter of table top cover 30 to provide a smooth straight adjoining seam 46 between table skirting 22 and table top cover 30. It should be recognized that alternating indented sections 33 preferably enable hook and loop fastener 42 or 44 to be recessed within indented sections 33 preventing a wavy appearance along adjoining seam 46 between table skirting 22 and table top cover 30. Moreover, by utilizing hook and loop fastener 42 and 44 between table skirting 22 and table top cover 30 preferably enables table skirting 22 to be quickly affixed to table top cover 30, to create a formal combination table top cover and table skirt retainer for an expo or banquet table, and enables table skirting 22 to be quickly removed from table top cover 30 during break-down and efficient storage of separate items (table T, table top cover 30, and table skirting 22) for later re-use.

Utilizing indented sections 33 of table top cover 30, table skirting 22, and attachment/fastener systems set forth or contemplated herein, table skirting 22 can be more easily and quickly attached to table top cover 30 without damaging the table T by applying staples or tacks or other fasteners as used by the conventional methods discussed above. Disassembly of table skirting 22 can also be performed simply by peeling off table skirting 22, and no staples or fasteners are to remain at the tables because such fasteners are not needed when affixing table skirting 22 to table top cover 30 positioned over table top TT of tables T. Disassembled table skirting 22 and table top cover 30 with table T can be simply stacked, placed in storage or packed up for transportation to the next venue for setup with a new set of tables T verses discarding previously stapled table skirting 22 after the particular banquet, expo, or tradeshow (non-recycling). Moreover, table top cover 30 may be permanently or removably affixed to table T by an adhesive, glue, screws, friction or the like.

As discussed above, the present disclosure provides new and convenient combination table top cover and skirt retainer, along with new methods of affixing such table top cover and table skirting of the disclosed combination table top cover and skirt retainer. Aspects of the disclosure can simplify the cumbersome and labor consuming process of applying table covers on tables, particularly for display tables of a trade show. In particular, when a trade show site has a great number of tables of standard sizes, the disclosed combination table top cover and skirt retainer can save a substantial amount of labor and installation costs by applying the table skirting to a table top cover. The tables covered with the combination table top cover and skirt retainer provides an appealing outlook for successful presentation in the trade shows. In addition, the tables covered by the disclosed combination table top cover and skirt retainer will not be damaged by staples or other fasteners.

With respect to the above description then, it is to be realized that the optimum dimensional relationships, to include variations in size, materials, shape, form, position, function and manner of operation, assembly and use, are intended to be encompassed by the present disclosure.

The foregoing description and drawings comprise illustrative embodiments. Having thus described exemplary embodiments, it should be noted by those skilled in the art that the disclosures within are exemplary only, and that various other alternatives, adaptations, and modifications may be made within the scope of the present disclosure. Many modifications and other embodiments will come to mind to one skilled in the art to which this disclosure pertains having the benefit of the teachings presented in the foregoing descriptions and the associated drawings. Although specific terms may be employed herein, they are used in a generic and descriptive sense only and not for purposes of limitation. Accordingly, the present disclosure is not limited to the specific embodiments illustrated herein, but is limited only by the following claims.

What is claimed is:

1. A combination table top cover and table skirting retainer system comprising:
a table top cover having a planar top and one or more sides, each said side extending downwardly from said planar top;
one or more indentations formed in at least one said side;
at least one table skirt having a first end opposite a second end; and
fastening means for detachably affixing said table skirt to said table top cover.

2. The system of claim 1, wherein said fastening means further comprises at least one first fastener of said fastening means affixed to said first end of said table skirt and at least one second fastener of said fastening means affixed within one of said one or more indentations.

3. The system of claim 2, wherein said at least one first fastener of said fastening means is a first hook or loop fastener and said at least one second fastener of said fastening means is a second mating hook or loop fastener.

4. The system of claim 1, wherein said fastening means are selected from a group consisting of snaps, hooks and grommets, adhesive, latch, magnets and combinations thereof.

5. The system of claim 1, wherein the length and the width of said table top cover are generally the same as the length and width of the table.

6. The system of claim 1, wherein said one or more indentations are formed to match the configuration and size of said fastening means.

7. The system of claim 1, wherein the length of said at least one table skirt is generally the same as the perimeter length of said table top cover.

8. The system of claim 1, wherein said table top cover provides a durable flat work surface.

9. The system of claim 1, wherein said table top cover provides a texturized flat work surface.

10. A method of forming a combination table top cover and table skirting retainer, said method comprising the steps of:
providing a table top cover having a planar top and one or more sides, each said side extending downwardly from said planar top, wherein each said side having one or more indentations formed in at least one said side;
providing at least one table skirt having a first end opposite a second end; and
detachably affixing said table skirt to said table top cover.

11. The method of claim 10, wherein said affixing step is achieved by affixing at least one first fastener to said first end of said table skirt and at least one second fastener to one of said one or more indentations.

12. The method of claim 11, wherein said affixing step is achieved by hook and loop fasteners.

13. The method of claim 10, wherein the length and the width of said table top cover are generally the same as the length and width of the table.

14. The method of claim 11, wherein said one or more indentations are formed to match the configuration and size of said at least one second fastener.

15. The method of claim 10, wherein said table top cover provides a durable flat work surface.

16. The method of claim 10, wherein said table top cover provides a texturized flat work surface.

17. A combination table top cover and table skirting retainer system comprising:
a table top cover having a planar top and one or more sides, each said side extending downwardly from said planar top;
one or more indentations formed in at least one said side;
at least one table skirt having a first end opposite a second end; and
a fastener, wherein said fastener detachably affixes said table skirt to said table top cover.

18. The system of claim 17, wherein said fastener further comprises at least one first member of said fastener affixed to said first end of said table skirt and at least one second member of said fastener affixed within one of said one or more indentations.

19. The system of claim 18, wherein said at least one first member of said fastener is a first hook or loop fastener and said at least one second member of said fastener is a second mating hook or loop fastener.

20. The system of claim 17, wherein said fastener is selected from a group consisting of snaps, hooks and grommets, adhesive, latch, magnets and combinations thereof.

21. The system of claim 17, wherein the length and the width of said table top cover are generally the same as the length and width of the table.

22. The system of claim 17, wherein said one or more indentations are formed to match the configuration and size of said fastener.

23. The system of claim 17, wherein the length of said at least one table skirt is generally the same as the perimeter length of said table top cover.

24. The system of claim 17, wherein said table top cover provides a durable flat work surface.

25. The system of claim 17, wherein said table top cover provides a texturized flat work surface.
